(19) United States
(12) Patent Application Publication
(10) Pub. No.: US 2002/0091727 A1
(43) Pub. Date: Jul. 11, 2002

(54) Document links

(76) Inventors: David Kerr, Farnborough (GB); David Harris, Swadlincote (GB); John Cafolla, Wallington (GB)

Correspondence Address: SWIDLER BERLIN SHEREFF FRIEDMAN, LLP, 3000 K STREET, NW, BOX IP, WASHINGTON, DC, 20007, US

(21) Appl. No.: 09/838,299

(22) Filed: Apr. 20, 2001

(30) Foreign Application Priority Data
Jan. 10, 2001 (GB) 0100630.3

(51) Int. Cl. G06F 17/21

(52) U.S. Cl. 707/501.1

(57) ABSTRACT

A method of defining a link between first and second applications windows on a processing system. The processing system has a database and at least one remote end station coupled to the database via a communications system. The method comprises operating the end station so as to:

a. access a first applications window;

b. cause the processing system to enter a link defining mode and access a second applications window, thereby causing the processing system to define a link between the first and second applications windows; and,

c. generate link data defining the link, the link data being stored on the database.

### FIELD OF THE INVENTION

The present invention relates to a method and apparatus for defining a link connecting first and second applications windows on a processing system.

### BACKGROUND TO THE INVENTION

Currently, there are many processing systems available which allow users to simultaneously operate a number of different applications windows. In a large scale database application such as an REP. (Enterprise Resource Planning) suite, each of these applications windows would typically represent a respective form, the forms being used for adding data to, or retrieving data from, the database.

Previously, navigation between such application windows has required the system users either to separately open the applications windows independently of each other, or alternatively to use links which are defined by a systems administrator.

In order to define such a link the system administrator must use a non-graphical, nonrepresentational task flow operating system. This system operates by having the system administrator define and save a set of nodes related to the relevant applications windows. One or more paths linking the nodes can then be defined, with details of the nodes and paths being used to create a record in a linking table, which is then saved to the database. Once this linking table has been created, it needs to be linked to the applications menu system which requires an additional step by the system administrator.

As this system is so complicated, it is not possible for individual users to define their own links between applications windows within the processing system. This therefore limits the links available to those defined by the system administrator. Furthermore, as the system administrator typically does not use the processing system and the applications windows, it is often the case that the system administrator does not know which links would be best defined between applications windows in the systems.

### SUMMARY OF THE INVENTION

In accordance with a first aspect of the present invention, we provide a method of defining a link between first and second applications windows on a processing system, the processing system having a database and at least one remote end station coupled to the database via a communications system, the method comprising operating the end station so as to:

a. access a first applications window;

b. cause the processing system to enter a link defining mode and access a second applications window, thereby causing the processing system to define a link between the first and second applications windows; and,

c. generate link data defining the link, the link data being stored on the database.

In accordance with a second aspect of the present invention, we provide a processing system for defining a link between first and second applications windows, the processing system comprising a database centre coupled to at least one end station via a communications network:

a. the database centre comprising:

i. a database; and,

ii. a centre processor coupled to the database;

b. the at least one remote end station comprising:

i. an end station processor; and,

ii. a display,

wherein, in use, the centre processor and the end station processor cooperate thereby allowing the user to:

(1) access a first application window;

(2) cause the processing system to enter a link defining mode and access a second application window, thereby causing the processing system to define a link between the first and second application windows; and,

(3) generate link data defining the link, the link data being stored on the database.

In accordance with a third aspect of the present invention, we provide an end station for use in a processing system for defining a link between first and second applications windows, the processing system including a database centre having a database, and a centre processor, the database centre being coupled to the end station via a communications network, the end station comprising:

i. an end station processor; and,

ii. a display,

wherein, in use, the end station processor is adapted to cooperate with the centre processor thereby allowing the user to:

(1) access a first application window;

(2) cause the processing system to enter a link defining mode and access a second application window, thereby causing the processing system to define a link between the first and second application windows; and,

(3) generate link data defining the link, the link data being stored on the database.

In accordance with a fourth aspect of the present invention, we provide a database centre for use in a processing system for defining a link between first and second applications windows, the processing system being coupled to an end station having an end station processor via a communications network, the database centre comprising:

i. a database; and,

ii. a centre processor coupled to the database,

wherein, in use, the centre processor and the end station cooperate thereby allowing the user to:

(1) access a first application window;

(2) cause the processing system to enter a link defining mode and access a second application window, thereby causing the processing system to define a link between the first and second application windows; and,

(3) generate link data defining the link, the link data being stored on the database.

Accordingly, the present invention provides a method and apparatus including a processing system, a database centre and an end station for defining a link between first and second applications windows. The technique allows a user to define links between the applications windows by simply accessing the appropriate applications windows and allowing the system to define the links. With no detailed technical knowledge of how the links are achieved or defined being required by the user, this allows the user to create the navigational shortcuts linking different applications windows in a far more intuitive way. This makes the system usable by system users as well as system administrators allowing links to be defined that are required in the day-to-day use of the system.

Typically the step of causing the processing system to define a link comprises causing the processing system to enter a link defining mode; and accessing the second applications window. However, the situation may be reversed in that the second applications window may be accessed before the processing system enters the link defining mode. The processing system can therefore be adapted to monitor whether one or two applications windows are currently accessed and if two windows are accessed, then a link can be defined between the two, whereas if only one applications window is accessed then the link is defined to the next applications window which is accessed.

Typically the step of accessing an applications window comprises causing the applications window to be displayed on a display at the end station. Thus, this corresponds to the opening of an applications window, such as a form, on an end station. However, alternative methods of accessing the applications windows may be used, for example by highlighting the applications windows in a list of alternative windows, or the like.

The link is usually defined to allow the second applications window to be accessed directly from the first applications window. Thus, the link will usually define a button or icon within the applications window which forms the link to the second applications window. This allows the button or icon to be selected thereby causing the second applications window to automatically opened. However, alternative links, such as a hyper-link, or a menu option, similar to the favourites option on an Internet browser, could be used.

Preferably each user of the processing system has a respective identifier which may be a secret password, and wherein the link data is stored in accordance with the identifier such that each user can define respective links. This allows each user of the system to define their own links between respective applications windows. This information can then be stored within the database allowing it to be accessed from any end station coupled to the system. This therefore allows system users to log on to the system using any terminal and still have their own previously defined links available to them. It will be realised that in this situation, various access levels could be defined allowing system administrators to define links which are available to all users of the system, whereas group supervisors can define links which are only made available to their own respective group, and individual users can define links which are only available to themselves.

The processing system usually defines a link by determining the first and second applications windows, generating link data including an indication of the first and second applications windows and transferring the link data to the database. As mentioned above however alternative systems can be used.

It will be realised that in the situation in which each user has a respective user identifier, the link data typically includes the user identifier. This allows the centre processor to store the link data in the database in accordance with the user identifier.

In this situation, the end station processor is adapted to receive and transfer the user identifier to the centre processor and the centre processor is adapted to transfer the link data stored in the database in accordance with the received user identifier, to the end station. However, this is not essential for the present invention as alternatively link data be stored on the end stations itself, or the like.

The database store may store applications data associated with the first and second applications windows. However, any suitable data may be stored in the database.

### BRIEF DESCRIPTION OF THE DRAWINGS

An example of the present invention will now be described with reference to the accompanying drawings, in which:

FIG. 1 is a schematic diagram of a processing system according to the present invention;

FIG. 2 is a schematic diagram of an end station according to the present invention;

FIG. 3 is a schematic diagram of a work flow according to the present invention;

FIG. 4 is an example of the image presented to a user on the display of an end station;

FIG. 5 is an example of the image of FIG. 4 including an applications window;

FIG. 6 is an example of the image of FIG. 4 including two applications windows;

FIG. 7 is an example of the image of FIG. 4 including an applications window having a link defined therein;

FIG. 8 is an example of a link LUT; and,

FIG. 9 is an example of a user LUT.

### DESCRIPTION OF THE EMBODIMENT

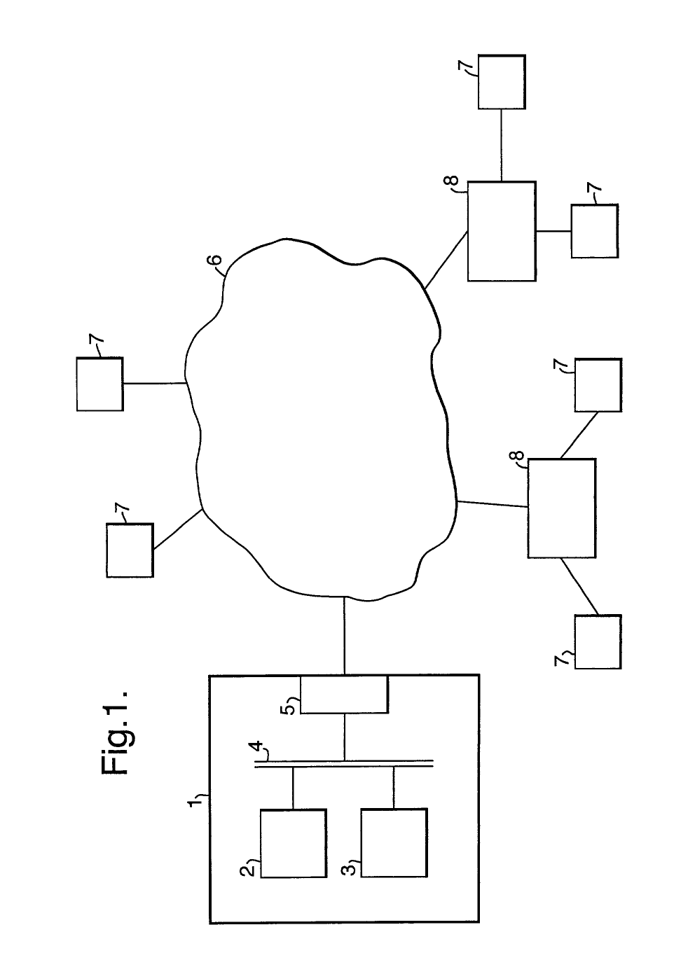

FIG. 1 is a schematic diagram of a processing system according to the present invention which in this example is adapted to operate an ERP. suite. As shown, the system comprises a database centre 1 which includes a database 2 which stores data for use by the processing system. The data will typically include financial and personnel data as used in the ERP. domain.

The processing centre 1 also includes a processor 3. The processor 3 and the database 2 are linked to a bus 4 which is in turn linked via a communications device 5, such as a modem, ISDN connection, or the like to a communications network 6, such as the Internet or an Ethernet or Token Ring LAN. The communications network 6 is in turn coupled to a number of system user end stations 7, either directly or via a communications centre 8 such as an Internet service provider, in the usual way.

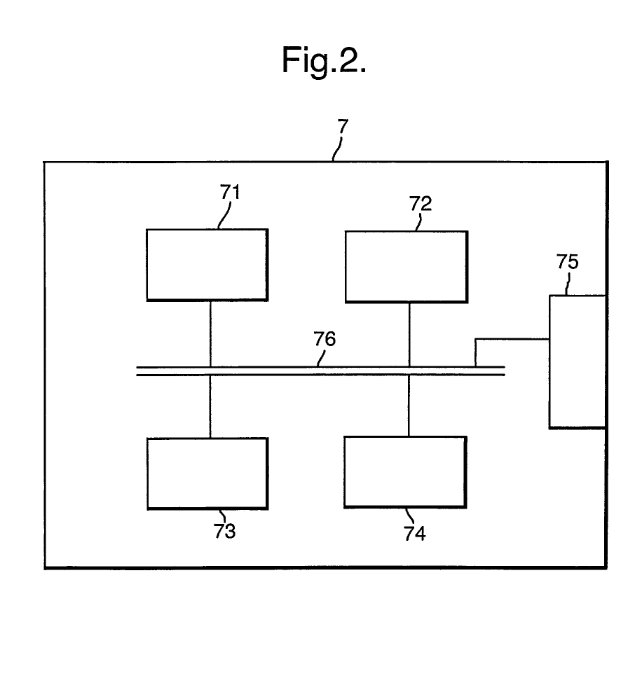

An example of an end station 7 suitable for use in the present invention is shown in more detail in FIG. 2. As shown, each end station includes an Input/Output device 71, a memory 72, a processor 73, a display 74 and a communications device 75 such as a modem, all of which are coupled together via a bus 76, as shown. It will be appreciated that the end station may therefore comprise a personal computer, a lap top, a palm top, a wireless communications device or the like.

It will be realised from the above that system users can therefore use the end stations 7 to obtain information from the database 2, via the communications network 6.

In order to use the system the system user will typically have to log onto the processing system by entering a user ID and a user password which are transferred via the communications network 6 to the processor 3. The processor 3 will compare the entered user ID and password with user data stored in the database 2 to determine whether the user has access to the system. If so, the processor 3 will communicate with the processor 73 of the end station 7 indicating that access to the system has been granted. It is then possible for the user to access any of the data stored in the database 2.

Operation of the system to define links in accordance with the present invention will now be described.

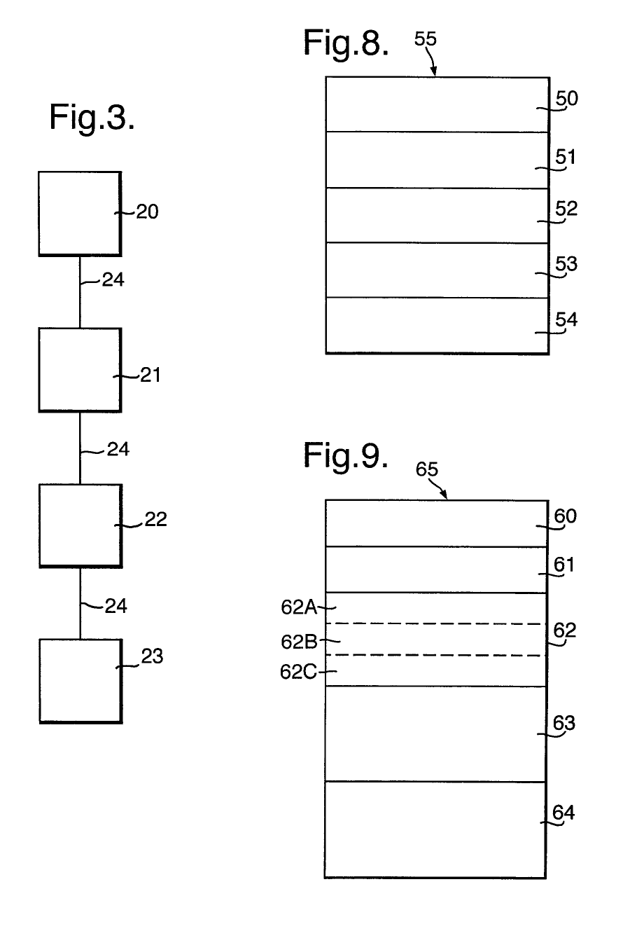

FIG. 3 presents a typical task flow which may need to be defined within the present invention. The task flow represents a series of navigation paths between respective forms which would need to be filled in when for example a new employee is hired by a company. Thus, as shown in the work flow of FIG. 3, a system user would have to fill in a person form 20, an address form 21, an assignment form 22, indicating the job the person is to hold, and a salary form 23. Thus, a series of links 24 could advantageously be used to link the forms 20, 21, 22, 23, in sequence so that once one form has been completed the other can be immediately accessed and completed in turn.

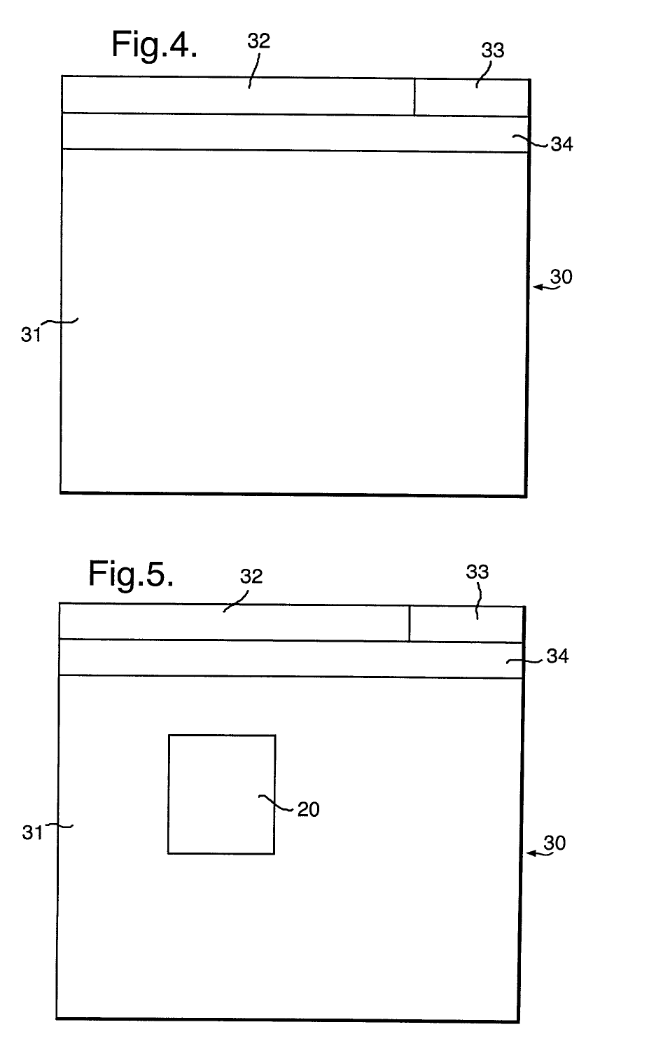

Once the user has logged onto the system, the user will typically be presented with an image on the display of the end station 7, as shown in FIG. 4. The screen 30 includes a working area 31 into which the user can open various application windows, a menu 32, a define link indicator 33 and a toolbar 34.

In order to enter new, or read current details of an employee, the system user will access a respective menu 32 and open an applications window containing a person form 20, as shown in FIG. 5. This will allow the system user to either download data regarding an employed person from the database 2, or alternatively to enter new data onto the system.

In either case, once data has been entered into the person form 20, the system user can then access an address form 21 from an appropriate menu 32. As will be appreciated by a person skilled in the art, this can be a relatively time consuming process requiring the opening of several menus and sub-menus. Accordingly, the system user may decide that as the address form 21 often needs to be used immediately after the person form 20, a link should be defined from the person form 20 to the address form 21.

In order to achieve this the system user simply selects a define link mode using either an appropriate option from the menu 32 or an appropriate button from the toolbar 34. Once accessed, a define link indicator 33 is used to indicate that the define link mode is in use.

The system can then operate in one of a number of ways to define the links.

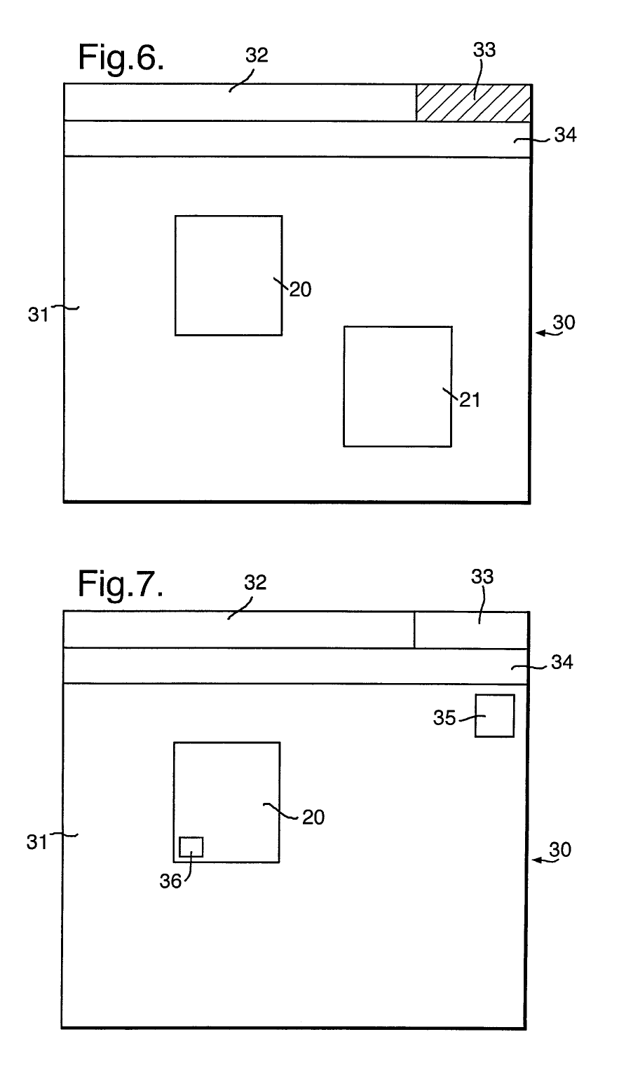

In the first example as shown in FIG. 6, if both the person form 20 and the address form 21 are currently open within the working area 31, upon entering the define link mode the processor 24 will define link data representing a link between the windows.

Alternatively if the define link mode is accessed when only the person form 20 is open within the working area 31, then when the address form 21 is opened, the processor 73 will operate to define a link between these two documents.

Alternatively, the define link mode may be accessed before either the person form 20 or the address form 21 is opened, such that when both forms are opened in sequence the link is defined.

The processor 24 will operate to define a link between the forms by generating link data in the form of a look-up table (LUT), an example of which is shown in FIG. 8. The link LUT 55 includes a user ID field 50, a pass user password field 51, a first application field 52 and a second application field 53. Additional details, such as details of how the link should be represented are stored in a link field 54.

In use the processor 73 will input the system users User ID and User password in the respective fields 50,51. The processor will then enter an identifier associated with the person form 20 in the first application field 52, and an identifier associated with the address form 21 in the second application field 53. This therefore defines a link for the specified user between the person form 20 and the address form 21.

At this point, the User can optionally enter details of how the link is to be displayed. Thus, for example the link may form a new entry in the menu system which only appears once the person form 20 is displayed, or alternatively the link may be defined as a button on a toolbar 34, or an icon which is displayed within the person form 20. This information is stored in the link field 54 of the link LUT 55.

This link LUT 55 is then transferred via the communications network 6 to the processor 3. The processor 3 will copy the data contained in the link LUT to a respective user LUT in the database 2. As will be appreciated by a person skilled in the art, a respective user LUT is required for each system user and the contents of the link LUT are therefore advantageously incorporated within the user LUT. An example of a suitable user LUT is shown in FIG. 9.

The user LUT 65 includes user ID and user password fields 60,61 respectively. A number of link data fields are also provided, with only three 62, 63, 64 being shown in this example. Each link data field 62, 63, 64 includes three sub-fields, which are shown as 62A, 62B, 62C for the link data field 62. Accordingly, data from the first and second applications fields 52, 53 and the link field 54, of a given link LUT are stored in an appropriate one of the sub-fields 62A, 62B, 62C. The remaining link fields are used to store details of other links defined by the other link LUTs.

The user data LUT is therefore an expanded version of a link data LUT which allows multiple links to be stored.

Each time the User accesses the processing system, the User ID and User password will be used to access at the respective User LUT from the database 2. The links defined within the User LUT are then used whenever the user accesses an appropriate one of the forms.

The data is typically transferred to the processor 73 of the end station 7 by transferring a copy of the user data LUT to the end station 7. This can then be stored in the memory 72 for subsequent retrieval by the processor 73, as required. Thus, each time the user opens an applications window containing the person form 20, the processor 73 will examine the user data LUT stored in the memory 72 and determine that a link should be defined between the person form 20 and the address form 21. The link will then be presented in an appropriate manner.

Alternatively however, the User data may simply be stored in the database 2 and then accessed as required to ensure that the links are correctly defined. Further alternatives are also envisaged such as the transfer of details of forms for which links are required. When the respective form is opened, the details of the link can then be downloaded from the database 2.

As mentioned above, the links may be defined in any one of a number of ways. Thus for example the link may appear as a button on the toolbar 34, or alternatively as an icon 35 in the working area 31, or alternatively as an icon 36 on the appropriate form 20 as shown in FIG. 7.

Once a link between the person form 20 and the address form 21 is defined, the processor 74 will exit the link defining so operation of the system can continue in the normal way. Further links, for example between the address form 21 and the Assignment form 22 can then be defined as described above.

Thus, it will be appreciated by a person skilled in the art that each user of the system may define respective links between documents. Furthermore as this is a very easy method of defining links this makes the system easy to operate.

Further developments that may be incorporated are that as a link between two applications windows is used, data used in the first applications window is automatically transferred to the second applications windows as appropriate. Thus, if a person form 20 is currently open and the system user opens a address form 21 using the defined link, then any information on the person form 20 which is also used on the address form 21 is automatically up-loaded into the address form 21. The data will be transferred either directly from the person form 20 if available, or will alternatively be transferred directly from the database 2. Alternatively, once the data has been added into the memory 72 it will be downloaded onto the database and stored in an appropriate place.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROMs, as well as transmission-type media, such as digital and analog communications links.

We claim:

1. A method of defining a link between first and second applications windows on a processing system, the processing system having a database and at least one remote end station coupled to the database via a communications system, the method comprising operating the end station so as to:
a. access a first applications window;
b. cause the processing system to enter a link defining mode and access a second applications window, thereby causing the processing system to define a link between the first and second applications windows; and,
c. generate link data defining the link, the link data being stored on the database.

2. A method according to claim 1, wherein step (b) comprises operating the end station so as to:
i. cause the processing system to enter a link defining mode; and then,
ii. access the second applications window.

3. A method according to claim 1, wherein the step of accessing an applications window comprises causing the applications window to be displayed on a display of the end station.

4. A method according to claim 1, wherein the link is defined to allow the second applications window to be accessed directly from the first applications window.

5. A method according to claim 1, wherein the end station is adapted to present the link within the first applications window.

6. A method according to claim 5, wherein the link is defined as an icon within the first applications window.

7. A method according to claim 1, wherein each user of the processing system has a respective identifier, and wherein the link data is stored in accordance with the respective user identifier such that each user can define respective links.

8. A processing system for defining a link between first and second applications windows, the processing system comprising a database centre coupled to at least one end station via a communications network:
a. the database centre comprising:
i. a database; and,
ii. a centre processor coupled to the database;
b. the at least one remote end station comprising:
i. an end station processor; and,
ii. a display,
wherein, in use, the centre processor and the end station processor cooperate thereby allowing the user to:
(1) access a first application window;
(2) cause the processing system to enter a link defining mode and access a second application window, thereby causing the processing system to define a link between the first and second application windows; and,
(3) generate link data defining the link, the link data being stored on the database.

9. A processing system according to claim 8, the display displaying an accessed applications window.

10. A processing system according to claim 8, wherein the step of defining a link comprises causing the end station processor to:
a. determine the first and second applications windows;
b. generate link data including an indication of the first and second applications windows; and,
c. transfer the link data to the database.

11. A processing system according to claim 10, wherein each user of the processing system has a respective user identifier, and wherein the link data includes the identifier such that each user can define respective links.

12. A processing system according to claim 10, wherein step (c) comprises causing the end station processor to transfer the link data to the centre processor, and wherein the centre processor is adapted to store the link data in the database in accordance with the user password.

13. A processing system according to claim 12, wherein in use the end station processor is adapted to receive and transfer the user identifier to the centre processor, and the centre processor is adapted to transfer any link data stored in the database in accordance with the received user identifier, to the end station.

14. An end station for use in a processing system for defining a link between first and second applications windows, the processing system including a database centre having a database, and a centre processor, the database centre being coupled to the end station via a communications network, the end station comprising:
i. an end station processor; and,
ii. a display,
wherein, in use, the end station processor is adapted to cooperate with the centre processor thereby allowing the user to:
(1) access a first application window;
(2) cause the processing system to enter a link defining mode and access a second application window, thereby causing the processing system to define a link between the first and second application windows; and,
(3) generate link data defining the link, the link data being stored on the database.

15. An end station according to claim 14, the display displaying the accessed applications windows.

16. An end station according to claim 14, wherein each user has a respective identifier, the end station further comprising a store for storing a user identifier received from a user.

17. A database centre for use in a processing system for defining a link between first and second applications windows, the processing system being coupled to an end station having an end station processor via a communications network, the database centre comprising:
i. a database; and,
ii. a centre processor coupled to the database,
wherein, in use, the centre processor and the end station cooperate thereby allowing the user to:
(1) access a first application window;
(2) cause the processing system to enter a link defining mode and access a second application window, thereby causing the processing system to define a link between the first and second application windows; and,
(3) generate link data defining the link, the link data being stored on the database.

18. A database centre according to claim 17, wherein the database stores applications data associated with the first and second applications windows.

19. A database centre according to claim 17, wherein each user of the processing system has a respective identifier such that each user can define respective links, and wherein the centre processor is adapted to store link data in accordance with the user identifier of the respective user who defined the links.
